(19) United States
(12) Patent Application Publication
(10) Pub. No.: US 2016/0173757 A1
(43) Pub. Date: Jun. 16, 2016

(54) CAMERA MODULE

(71) Applicant: Samsung Electro-Mechanics Co., Ltd., Suwon-si (KR)

(72) Inventor: Kyung Hoon CHOI, Suwon-si (KR)

(73) Assignee: Samsung Electro-Mechanics Co., Ltd., Suwon-si (KR)

(21) Appl. No.: 14/957,682

(22) Filed: Dec. 3, 2015

(30) Foreign Application Priority Data
Dec. 15, 2014 (KR) 10-2014-0180661

(51) Int. Cl. H04N 5/232; H04N 5/225; G02B 7/09

(52) U.S. Cl. CPC H04N 5/23212; G02B 7/09; H04N 5/2258; H04N 5/2252

(57) ABSTRACT

There is provided a camera module including a first camera unit, a second camera unit, and an actuator. The actuator is configured to obtain a resolving power value of an image captured by the second camera unit and move a lens barrel of the first camera unit in an optical axis direction to adjust the focal length of the first camera unit according to the resolving power value.

### CROSS-REFERENCE TO RELATED APPLICATION

This application claims the benefit under 35 USC 119(a) of Korean Patent Application No. 10-2014-0180661 filed on Dec. 15, 2014, with the Korean Intellectual Property Office, the disclosure of which is incorporated herein by reference.

### BACKGROUND

1. Field

The following description relates to a camera module rapidly performing autofocusing.

2. Description of Related Art

Camera modules commonly have an autofocusing function. Such an autofocusing function allows a subject located within a short distance or at relatively long distance to be clearly imaged and captured by the camera module. The autofocusing functions is performed by a control system and a motor or tunable optical element in the camera module to focus automatically or on a manually selected point or area, whether the point or the area is at a short distance from the camera module or at a relatively long distance from the camera module.

The focusing of the camera module is performed by adjusting a position of a lens barrel according to a distance between the camera module and a subject whose image is to be captured. For example, while moving a lens barrel toward an image side from an object side, the camera module gathers image information according to positions of a lens barrel, determines a position of collected image information satisfying a reference value, and moves the lens barrel to the determined position, thus performing focusing.

However, with this method, a camera module consumes a large amount of power due to a relatively long movement of the lens barrel. In addition, the camera module may take a significant amount of time, and therefore power, to determine a final position of the lens barrel, making it difficult to capture a video or an image of the subject during poor ambient conditions, such as at night.

Thus, a camera module is needed that is configured to rapidly perform focusing and capturing of an image.

### SUMMARY

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

In accordance with an embodiment, there is provided a camera module, including: a first camera unit; a second camera unit; and an actuator configured to obtain a resolving power value of an image captured by the second camera unit and move a lens barrel of the first camera unit in an optical axis direction to adjust the focal length of the first camera unit according to the resolving power value.

The first camera unit may include an adjustable focal length and the second camera unit includes a fixed focal length.

The second camera unit may include an angle of view wider than an angle of view of the first camera unit.

An imaging area of the second camera unit may overlap with an imaging area of the first camera unit.

The first camera unit may include a higher resolution than that of the second camera unit.

The second camera unit may include a focal length longer than a focal length of the first camera unit.

The second camera unit may be inclined at a first angle with respect to an optical axis of the first camera unit.

The actuator may include: a permanent magnet in the lens barrel; and a coil in a first housing accommodating the lens barrel.

The camera module may further include: a housing including the first camera unit and the second camera unit.

In accordance with an embodiment, there is provided a camera module, including: a first camera unit; a second camera unit; a third camera unit; and an actuator configured to obtain resolving power values of images captured by the second camera unit and the third camera unit, and move a lens barrel of the first camera unit in an optical axis direction to adjust the focal length of the first camera unit according to the resolving power values.

The first camera unit may include an adjustable focal length, the second camera unit includes a fixed focal length, and the third camera unit includes a fixed focal length.

The second camera unit and the third camera unit may include an angle of view wider than an angle of view of the first camera unit.

The second camera unit and the third camera unit may be inclined at a first angle with respect to an optical axis of the first camera unit.

The third camera unit may be symmetrical to the second camera unit in relation to the first camera unit.

The third camera unit may include an angle of view equal to an angle of view of the second camera unit.

Imaging areas of the second camera unit and the third camera unit may overlap with an imaging area of the first camera unit.

In accordance with an embodiment, there is provided a method of a camera module, including: simultaneously capturing an image of a subject using a first camera unit and a second camera unit; analyzing a resolving power of the captured image at the second camera unit; calculating a distance between the camera module and the subject based on the resolving power value; adjusting a focal length at the first camera unit based on the distance; and performing imaging of the subject using the first camera unit.

The method may further include correcting a position of a first lens barrel of the first camera unit to fit a distance to the subject.

In response to the distance determined by the second camera unit being less than a preset distance, the method may further include moving a first lens barrel of the first camera unit in a direction toward a first image sensor of the first camera unit.

In response to the distance determined by the second camera unit being greater than the preset distance, the method may further include moving a first lens barrel of the first camera unit in a direction away from a first image sensor of the first camera unit.

The first camera unit may include an adjustable focal length and the second camera unit includes a fixed focal length.

The second camera unit may include an angle of view wider than an angle of view of the first camera unit.

Other features and aspects will be apparent from the following detailed description, the drawings, and the claims.

### BRIEF DESCRIPTION OF DRAWINGS

The above and other aspects, features and advantages of the present disclosure will be more clearly understood from the following detailed description taken in conjunction with the accompanying drawings, in which:

FIG. 1 is a view illustrating a configuration of a camera module, according to an embodiment;

FIG. 2 is a view illustrating a configuration of a first camera unit illustrated in FIG. 1;

FIG. 3 is a view illustrating an example of an image captured by the first camera unit illustrated in FIG. 2;

FIG. 4 is a view illustrating a configuration of a second camera unit illustrated in FIG. 1;

FIG. 5 is a view illustrating an example of an image captured by the second camera unit illustrated in FIG. 4;

FIG. 6 is a view illustrating distribution of resolving power of the second camera unit with respect to the captured image illustrated in FIG. 3;

FIG. 7 is a flowchart illustrating a method for adjusting a focal length of a camera module, according to an embodiment;

FIG. 8 is a view illustrating a configuration of a camera module, according to another embodiment;

FIG. 9 is a view illustrating a configuration of a camera module, according to another embodiment;

FIG. 10 is a view illustrating a configuration of a third camera unit illustrated in FIG. 9; and

FIG. 11 is a view illustrating a configuration of a camera module according to another exemplary embodiment in the present disclosure.

Throughout the drawings and the detailed description, the same reference numerals refer to the same elements. The drawings may not be to scale, and the relative size, proportions, and depiction of elements in the drawings may be exaggerated for clarity, illustration, and convenience.

### DETAILED DESCRIPTION

The following detailed description is provided to assist the reader in gaining a comprehensive understanding of the methods, apparatuses, and/or systems described herein. However, various changes, modifications, and equivalents of the methods, apparatuses, and/or systems described herein will be apparent to one of ordinary skill in the art. The sequences of operations described herein are merely examples, and are not limited to those set forth herein, but may be changed as will be apparent to one of ordinary skill in the art, with the exception of operations necessarily occurring in a certain order. Also, descriptions of functions and constructions that are well known to one of ordinary skill in the art may be omitted for increased clarity and conciseness.

The features described herein may be embodied in different forms, and are not to be construed as being limited to the examples described herein. Rather, the examples described herein have been provided so that this disclosure will be thorough and complete, and will convey the full scope of the disclosure to one of ordinary skill in the art.

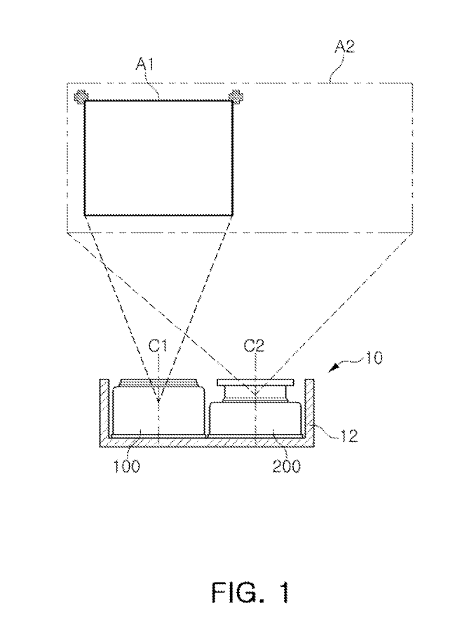

A camera module, according to an embodiment, is described with reference to FIG. 1.

A camera module 10, according to an embodiment, includes a first camera unit 100 and a second camera unit 200. The camera module 10 further includes a housing 12 accommodating the first camera unit 100 and the second camera unit 200.

The camera module 10 is installed in a small terminal (for example, a cellular phone) to capture a still image or video of a subject.

The first camera unit 100 performs autofocusing. For example, the first camera unit 100 includes an actuator to move one or more lenses along an optical axis C1.

The first camera unit 100 includes a first imaging area A1. For example, the first camera unit 100 has a first imaging area A1 smaller than a user's field of view.

The first camera unit 100 adjusts a focal length of a lens to capture a sharp image of a subject or an object.

The second camera unit 200 has a fixed focus. For example, the second camera unit 200 has a longer focal length than a focal length of the first camera unit 100. Thus, the second camera unit 200 is configured to capture a relatively sharp image of a subject at a considerable distance.

The second camera unit 200 captures an image at substantially the same point as that of the first camera unit 100. For example, an optical axis C2 of the second camera unit 200 is parallel to the optical axis C1 of the first camera unit 100. In another example, the second camera unit 200 is disposed to be adjacent to the first camera unit 100.

The second camera unit 200 has a wide angle of view. For example, the second camera unit 200 has an angle of view substantially the same as or wider than that of the user's vision. In another example, the second camera unit 200 has an angle of view wider than an angle of view of the first camera unit 100. For example, the second imaging area A2 of the second camera unit 200 is greater than the first imaging area A1 of the first camera unit 100.

The second camera unit 200 has the second imaging area A2 to include the first imaging area A1 of the first camera unit 100. For example, the second camera unit 200 is disposed on one side of the first camera unit 100 and obtains the second imaging area A2 to include the first imaging area A1 of the first camera unit 100. However, the second imaging area A2 does not necessarily include the entire first imaging area A1. For example, the second imaging area A2 of the second camera unit 200 overlaps with a portion or a considerable portion of the first imaging area A1 .

The camera module 10 includes the first camera unit 100 and the second camera unit 200, as a single body. For example, the camera module 10 includes the housing 12 accommodating the first camera unit 100 and the second camera unit 200.

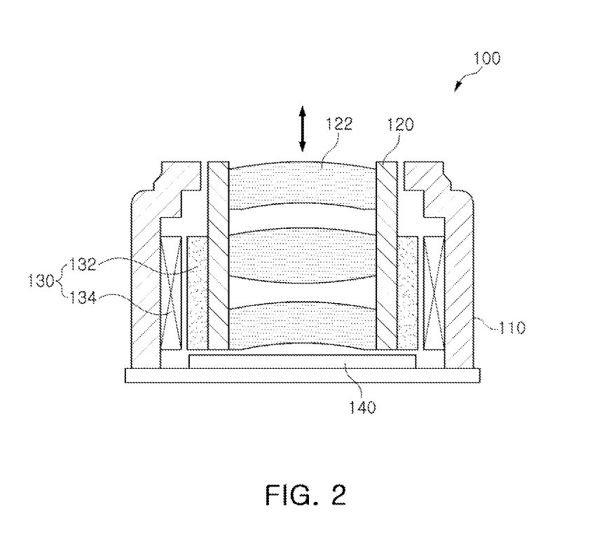

The first camera unit will be described with reference to FIG. 2.

The first camera unit 100 includes a first housing 110, a first lens barrel 120, and a first image sensor 140.

The first housing 110 accommodates the first lens barrel 120 and the first image sensor 140. For example, the first housing 110 is formed to have a cylindrical shape to accommodate the first lens barrel 120 and the first image sensor 140 therein. The cylindrical shape may include various shapes such as circle bases, oval bases, rectangular bases or other similar shapes.

The first lens barrel 120 accommodates one or more lenses 122. In one example, the first lens barrel 120 includes three lenses 122. However, the number of lenses 122 accommodated in the first lens barrel 120 is not limited to three. For example, two or less lenses or four or more lenses may be accommodated in the first lens barrel 120.

The first image sensor 140 converts an image captures and formed through the lens 122 into an electrical signal. For example, the first image sensor 140 is a charge coupled device (CCD) or a complementary metal-oxide semiconductor (CMOS).

The first camera unit 100 has an autofocusing function. For example, the first camera unit 100 includes the actuator 130 configured to move the first lens barrel 120 along the optical axis C1. The actuator 130 is a structural device able to convert electrical energy into a physical force. For example, the actuator 130 includes a magnet 132 and a coil 134. In another example, the actuator 130 is a piezoelectric element. However, the configuration of the actuator 130 is not limited thereto.

In an embodiment, the actuator 130 includes the magnet 132 and the coil 134. The magnet 132 is formed on the first lens barrel 120. For example, the magnet 132 is formed on a side surface of the first lens barrel 120. The coil 134 is formed on the first housing 110. For example, the coil 134 is formed on an inner surface of the first housing 110 such that the coil 134 faces the magnet 132.

The actuator 130 generates a driving force according to an external signal and moves the first lens barrel 120 in the optical axis direction. For example, when a controller (not shown) in the first camera unit 100 or in the camera module 10 that a subject is close to the first camera unit 100, the actuator 130 moves the first lens barrel 120 toward the first image sensor 140. In another example, when the controller determines that a subject is distant from the first camera unit 100, the actuator 130 moves the first lens barrel 120 in a direction away from the first image sensor 140.

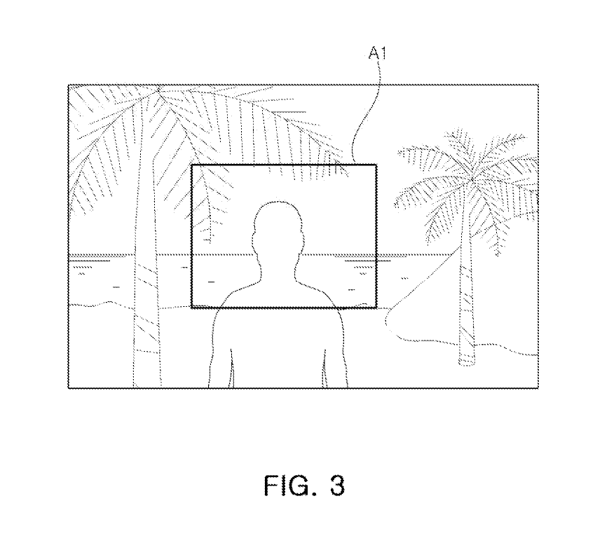

An imaging area of the first camera unit will be described with reference to FIG. 3.

The first camera unit 100 has a substantially narrow angle of view. For example, as illustrated in FIG. 3, the first camera unit 100 has a first imaging area A1 smaller than a field of view of the user.

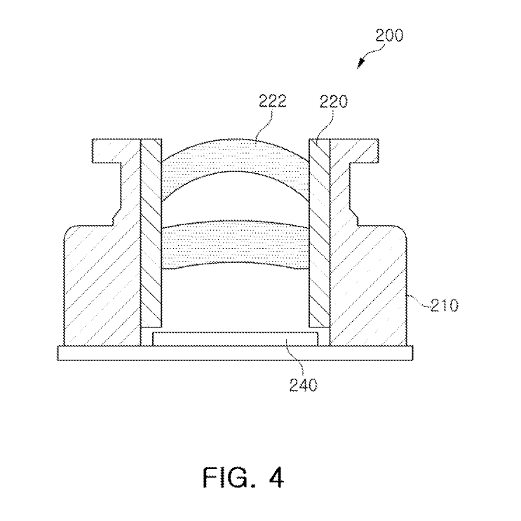

The second camera unit will be described with reference to FIG. 4.

The second camera unit 200 includes a second housing unit 210, a second lens barrel 220, and a second image sensor 240.

The second housing 210 accommodates the second lens barrel 220 and the second image sensor 240. For example, the second housing 210 has a cylindrical shape to accommodate the second lens barrel 220 and the second image sensor 240 therein. The cylindrical shape may include various shapes such as circle bases, oval bases, rectangular bases or other similar shapes.

The second lens barrel 220 accommodates one or more lenses 222. In one example, as shown in FIG. 2, the second lens barrel 220 includes two lenses 222. However, the number of lenses 222 accommodated in the second lens barrel 220 is not limited to two. For example, one, two, three, four, or more lenses may be accommodated in the second lens barrel 220. An optical system including one or more lenses 222 produces a wide angle of view. The optical system composed of the lenses 222 includes, in one embodiment, one or more fish-eye lenses.

The second image sensor 240 converts an image formed by the lens 222 into an electrical signal. For example, the second image sensor 240 is a CCD or a CMOS.

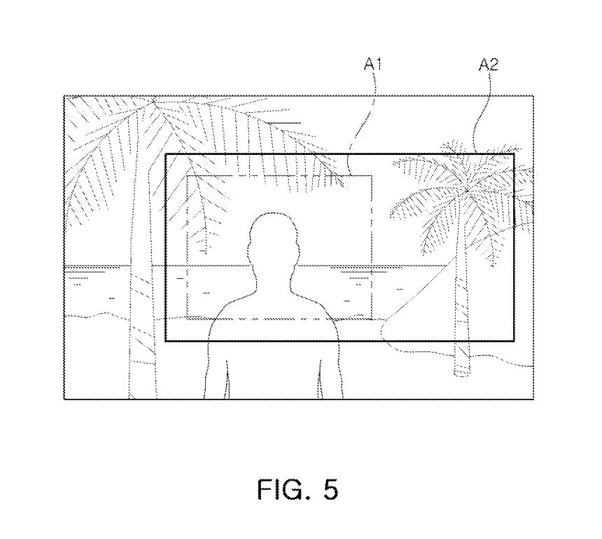

An imaging area of the second camera unit will be described with reference to FIG. 5.

The second camera unit 200 has a substantially wide angle of view. For example, as illustrated in FIG. 5, the second camera unit 200 has a second imaging area A2 greater than the first imaging area A1 of the first camera unit 100. The second imaging area A2 overlaps with the first imaging area A1. In one embodiment, the second imaging area A2 overlaps with and entirely covers the first imaging area A1. In another example, the second imaging area A2 partially overlaps with the first imaging area A1. For example, the second imaging area A2 includes a half or more of the first imaging area A1.

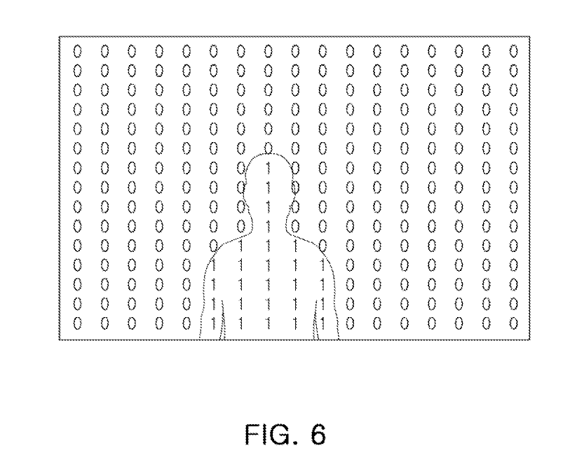

A method for measuring a distance using the second camera unit will be described with reference to FIG. 6.

The second camera unit 200 has a preset resolving power value. For example, the second camera unit 200 has a resolving power value equal to or less than a minimum focal length of the first camera unit 100.

When a range of the preset resolving power is satisfied, each pixel forming the second image sensor 240 of the second camera unit 200 transmits a first electrical signal (for example, “1”), and when the range of the preset resolving power is not satisfied, each pixel forming the second image sensor 240 of the second camera unit 200 transmits a second electrical signal (for example, “0”). Also, the second image sensor 240 calculates an overall resolving power value with respect to a captured image, as a numerical value, by adding and determining values of the pixels. For example, the second image sensor 240 calculates a resolving power value as a percentage (%).

The second camera unit 200 calculates a distance on the basis of a resolving power value. For example, when a subject or object, from which an image is to be taken, and the second camera unit 200 are spaced apart by a short distance, a high resolving power value is obtained, and when the object and the second camera unit 200 are spaced apart from each other by a long distance, a low resolving power value is obtained. As a result, the high resolving power value and the low resolving power value are used as data to calculate the distance between the subject or the object and the second camera unit 200 and are defined or set in advance. For example, when a resolving power value is calculated as 100%, the second camera unit 200 determines a distance to a subject as 10 cm. In another example, when a resolving power value is calculated as 50%, the second camera unit 200 determines a distance to a subject as 1 m. In another example, when a resolving power value is calculated as 10%, the second camera unit 200 determines a distance to a subject as 5 m.

Thus, the camera module 10 rapidly determines a distance to a subject through resolving power of the second camera unit 200.

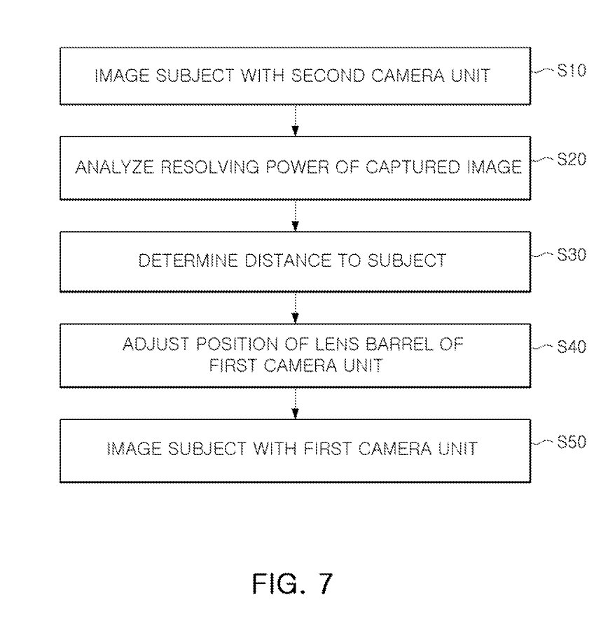

A method to adjust a focal length of a camera module, according to an embodiment, will be described with reference to FIG. 7.

The camera module 10 rapidly captures an image of a subject through the following operations.

At operation S10, the method performed at the camera module 10 obtains an image using the second camera unit 200.

In operation S10, an image of a subject is obtained by the second camera unit 200. For example, the second camera unit 200 simultaneously captures an image of a subject or an object with the first camera unit 100. The captured image is processed by a controller, a processor, or the second image sensor 240 of the second camera unit 200.

At operation S20, the method performed at the camera module 10 analyzes a resolving power of a captured image.

In operation S20, the resolving power of the captured image is analyzed based on an electrical signal collected at the second camera unit 200. For example, the second camera unit 200 calculates the captured image as a resolving power value (%) according to a preset reference.

At operation S30, the method performed at the camera module 10 determines a distance to the subject or the object.

In operation S30, the distance to the subject is calculated through the resolving power value (%). For example, the second camera unit 200 determines a distance corresponding to a resolving power value (%) based on preset data. For example, when a resolving power value is calculated as 100%, the second camera unit 200 determines a distance to a subject as 10 cm. In another example, when a resolving power value is calculated as 50%, the second camera unit 200 determines a distance to a subject as 1 m. In another example, when a resolving power value is calculated as 10%, the second camera unit 200 determines a distance to a subject as 5 m.

At operation S40, the method performed at the camera module 10 adjusts a focal length.

In operation S40, the focal length is adjusted by the first camera unit 100. For example, in this operation, the first camera unit 100 adjusts a focal length on the basis of distance information determined by the second camera unit 200. For example, when the distance information determined by the second camera unit 200 is less than a preset distance, the actuator 130 of the first camera unit 100 moves the first lens barrel 120 in a direction toward the first image sensor 140. In another example, when distance information determined by the second camera unit 200 is greater than the preset distance, the actuator 130 of the first camera unit 100 moves the first lens barrel 120 in a direction away from the first image sensor 140.

At operation S50, the method performed at the camera module 10 performs imaging using the first camera unit 100.

In operation S50, the subject is imaged or produced by the first camera unit 100. In this operation, because a position of the first lens barrel 120 is corrected to fit the distance to the subject, the first camera unit 100 captures a sharp image of the subject.

Through the operations described above, the camera module 10 determines the distance information between the camera module 10 and the subject from image information of the subject obtained by the second camera unit 200 and; thus, a focal length of the first camera unit 100 is rapidly calculated.

In addition, the camera module 10 accurately calculates the distance information from the image information of the subject obtained by the second camera unit 200, without or minimizing unnecessary driving of the first lens barrel 120 to adjust focus.

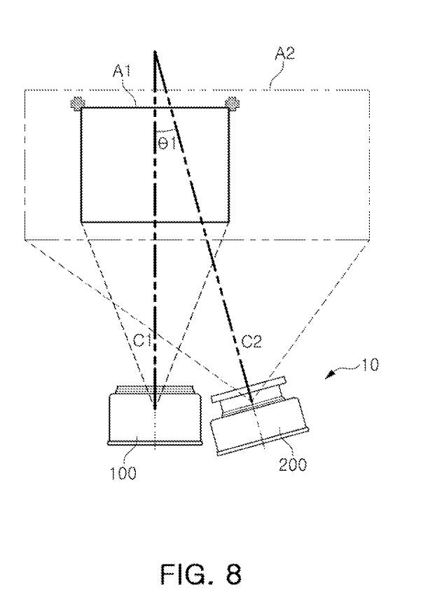

A camera module, according to another embodiment, will be described with reference to FIG. 8.

The camera module 10, according to an embodiment, differs from the camera module 10 described in the previous embodiment with respect to the dispositions of the first camera unit 100 and the second camera unit 200. For example, the optical axis C1 of the first camera unit 100 and the optical axis C2 of the second camera unit 200 may not be parallel to each other. For example, the second camera unit 200 is disposed to have an optical axis C2 inclined at a first angle θ1 with respect to the optical axis C1 of the first camera unit 100.

The camera module 10 advantageously produces the first imaging area A1 of the first camera unit 100 and the second imaging area A2 of the second camera unit 200 to substantially correspond to each other.

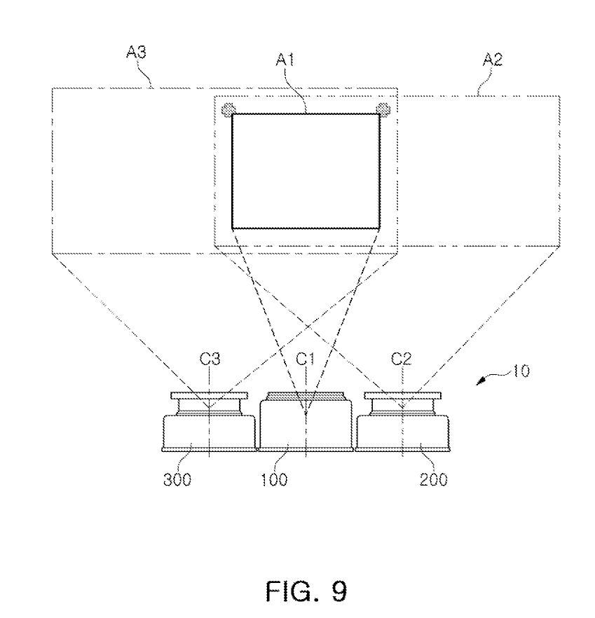

A camera module, according to another embodiment, will be described with reference to FIG. 9.

The camera module 10, according to an exemplary embodiment, differs from the camera module described in the previous embodiment in that a third camera unit 300 is provided. For example, the third camera unit 300 is disposed on a side of the first camera unit 100 or next to the first camera unit 100. In another example, the third camera unit 300 is disposed in a position symmetrical to the second camera unit 200 in relation to the first camera unit 100.

The camera module 10 accurately calculates a distance to a subject by determining a distance to the subject through resolving powers of a captured image of the second camera unit 200 and the third camera unit 300.

Thus, the camera module 10, according to an embodiment, advantageously obtains a high resolution image.

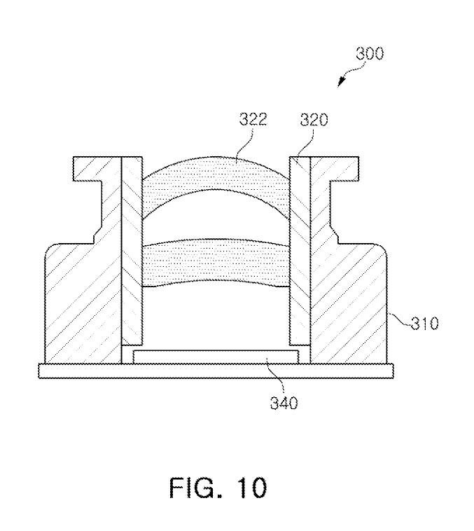

The third camera unit will be described with reference to FIG. 10.

The third camera unit 300 includes a third housing 310, a third lens barrel 320, and a third image sensor 340.

The third housing 310 accommodates the third lens barrel 320 and the third image sensor 340. For example, the third housing 310 has a cylindrical shape to accommodate the third lens barrel 320 and the third image sensor 340 therein. The cylindrical shape may include various shapes such as circle bases, oval bases, rectangular bases or other similar shapes.

The third lens barrel 320 accommodates one or more lenses 322. For example, the third lens barrel 320 includes two lenses 322. However, the number of lenses 322 accommodated in the third lens barrel 320 is not limited to two. For example, one, two, three, or four, or more lenses may be accommodated in the third lens barrel 320. An optical system composed of one or more lenses 322 may realize a wide angle of view. For example, an optical system composed of the lens 322 includes one or more fish-eye lenses.

The third image sensor 340 converts an image formed by the lens 322 into an electrical signal. For example, the third image sensor 340 is a CCD or a CMOS.

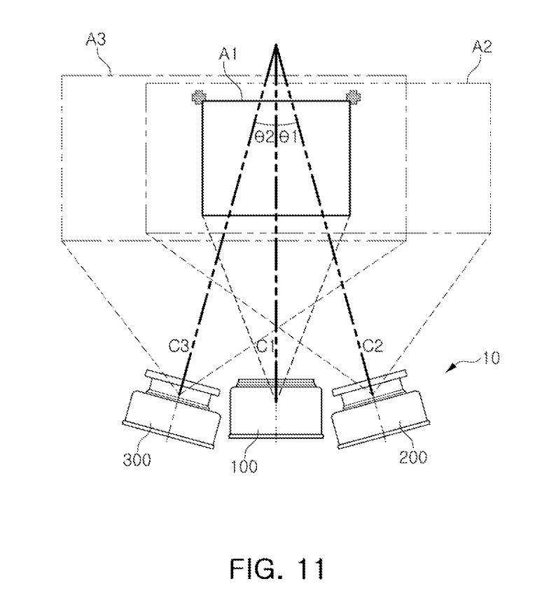

A camera module, according to another embodiment, will be described with reference to FIG. 11.

The camera module 10, according to an embodiment, differs from the camera module according to the previous embodiments with respect to the dispositions of the second camera unit 200 and the third camera unit 300. For example, the optical axis C2 of the second camera unit 200 and the optical axis C3 of the third camera unit 300 may not be parallel to the optical axis C1 of the first camera unit 100. For example, the second camera unit 200 is disposed to have the optical axis C2 inclined at a first angle θ1 with respect to the optical axis C1 of the first camera unit 100, and the third camera unit 300 is disposed to have the optical axis C2 inclined at a second angle θ2 with respect to the optical axis C1 of the first camera unit 100.

The camera module 10 advantageously makes the second imaging area A2 of the second camera unit 200 and the third imaging area A3 of the third camera unit 300 to correspond to the first imaging area A1 of the first camera unit 100.

As set forth above, the camera module, according to various embodiments, rapidly performs imaging of a subject or an object.

While this disclosure includes specific examples, it will be apparent to one of ordinary skill in the art that various changes in form and details may be made in these examples without departing from the spirit and scope of the claims and their equivalents. The examples described herein are to be considered in a descriptive sense only, and not for purposes of limitation. Descriptions of features or aspects in each example are to be considered as being applicable to similar features or aspects in other examples. Suitable results may be achieved if the described techniques are performed in a different order, and/or if components in a described system, architecture, device, or circuit are combined in a different manner, and/or replaced or supplemented by other components or their equivalents. Therefore, the scope of the disclosure is defined not by the detailed description, but by the claims and their equivalents, and all variations within the scope of the claims and their equivalents are to be construed as being included in the disclosure.

What is claimed is:

1. A camera module, comprising:
a first camera unit;
a second camera unit; and
an actuator configured to obtain a resolving power value of an image captured by the second camera unit and move a lens barrel of the first camera unit in an optical axis direction to adjust the focal length of the first camera unit according to the resolving power value.

2. The camera module of claim 1, wherein the first camera unit comprises an adjustable focal length and the second camera unit comprises a fixed focal length.

3. The camera module of claim 1, wherein the second camera unit comprises an angle of view wider than an angle of view of the first camera unit.

4. The camera module of claim 1, wherein an imaging area of the second camera unit overlaps with an imaging area of the first camera unit.

5. The camera module of claim 1, wherein the first camera unit comprises a higher resolution than that of the second camera unit.

6. The camera module of claim 1, wherein the second camera unit comprises a focal length longer than a focal length of the first camera unit.

7. The camera module of claim 1, wherein the second camera unit is inclined at a first angle with respect to an optical axis of the first camera unit.

8. The camera module of claim 1, wherein the actuator comprises:
a permanent magnet in the lens barrel; and
a coil in a first housing accommodating the lens barrel.

9. The camera module of claim 1, further comprising:
a housing comprising the first camera unit and the second camera unit.

10. A camera module, comprising:
a first camera unit;
a second camera unit;
a third camera unit; and
an actuator configured to obtain resolving power values of images captured by the second camera unit and the third camera unit, and move a lens barrel of the first camera unit in an optical axis direction to adjust the focal length of the first camera unit according to the resolving power values.

11. The camera module of claim 10, wherein the first camera unit comprises an adjustable focal length, the second camera unit comprises a fixed focal length, and the third camera unit comprises a fixed focal length.

12. The camera module of claim 10, wherein the second camera unit and the third camera unit comprise an angle of view wider than an angle of view of the first camera unit.

13. The camera module of claim 10, wherein the second camera unit and the third camera unit are inclined at a first angle with respect to an optical axis of the first camera unit.

14. The camera module of claim 10, wherein the third camera unit is symmetrical to the second camera unit in relation to the first camera unit.

15. The camera module of claim 10, wherein the third camera unit comprises an angle of view equal to an angle of view of the second camera unit.

16. The camera module of claim 10, wherein imaging areas of the second camera unit and the third camera unit overlap with an imaging area of the first camera unit.

17. A method of a camera module, comprising:
simultaneously capturing an image of a subject using a first camera unit and a second camera unit;
analyzing a resolving power of the captured image at the second camera unit;
calculating a distance between the camera module and the subject based on the resolving power value;
adjusting a focal length at the first camera unit based on the distance; and
performing imaging of the subject using the first camera unit.

18. The method of claim 17, further comprising:
correcting a position of a first lens barrel of the first camera unit to fit a distance to the subject.

19. The method of claim 17, wherein in response to the distance determined by the second camera unit being less than a preset distance, further comprising:
moving a first lens barrel of the first camera unit in a direction toward a first image sensor of the first camera unit.

20. The method of claim 17, wherein in response to the distance determined by the second camera unit being greater than the preset distance, further comprising:
moving a first lens barrel of the first camera unit in a direction away from a first image sensor of the first camera unit.

21. The method of claim 17, wherein the first camera unit comprises an adjustable focal length and the second camera unit comprises a fixed focal length.

22. The method of claim 17, wherein the second camera unit comprises an angle of view wider than an angle of view of the first camera unit.
